(19) United States
(12) Patent Application Publication
(10) Pub. No.: US 2012/0228865 A1
(43) Pub. Date: Sep. 13, 2012

(54) Independently expandable double containment joint

(76) Inventors: Kevin Sopoliga, Fair Haven, MI (US); Craig Szachta, Clinton Township, MI (US)

(21) Appl. No.: 12/932,864

(22) Filed: Mar. 8, 2011

(51) Int. Cl. F16L 7/00; F16L 9/18; F16L 17/06

(52) U.S. Cl. 285/123.15; 285/344; 138/114

(57) ABSTRACT

A double containment pipe system with an expandable joint. The double containment pipe system may comprise an inner, or carrier, pipe assembly and an outer, or containment, pipe assembly. The expandable joint allows the inner, or carrier, pipe assembly and an outer, or containment, pipe assembly to expand axially independently. Such an expandable joint for a double containment pipe system may be beneficial where the carrier and containment pipe assemblies expand or contract at different rates due to different materials and/or different temperature environments.

### FIELD

The present invention relates to piping and piping joints. More specifically, the present invention relates to piping joints imparting movable aspects to joined pipes.

### BACKGROUND

Pipes having joints for joining two or more pipe sections and double containment pipes having an inner piping system situated within an outer piping system are known. The purpose of the outer piping system is often to catch and contain fluids that leak from the inner piping system. For this reason, double containment pipes are sometimes used to carry hazardous fluids.

### SUMMARY

In one general aspect, the present invention is directed to a double containment pipe system with an expandable joint. The double containment pipe system may comprise an inner, or carrier, pipe assembly and an outer, or containment, pipe assembly. The expandable joint allows the inner, or carrier, pipe assembly and an outer, or containment, pipe assembly to expand axially independently. Such an expandable joint for a double containment pipe system may be beneficial where the carrier and containment pipe assemblies expand or contract at different rates due to different materials and/or different temperature environments. For example, where the double containment pipe system is outside, the outer containment pipe may be exposed to a different temperature profile, and thereby expand and contract differently, than the inner carrier pipe assembly, especially if the inner carrier pipe assembly is carrying above-ambient temperature fluids.

In another general aspect of the present invention, a containment pipe assembly is provided that includes a containment pipe joint having first and second containment pipe joint sections. The first and second containment pipe joint sections may define a first longitudinal length of the containment pipe assembly. In particular containment pipe assemblies, the first containment pipe joint section is axially movable relative to the second containment pipe joint section such that a relative axial movement of the first containment pipe joint section proportionally changes the first longitudinal length.

In yet another general aspect of the present invention, a carrier pipe assembly that is at least partially disposed within the containment pipe assembly is provided. A carrier pipe assembly may include a carrier pipe joint having first and second carrier pipe joint sections. The first and the second carrier pipe joint sections may define a second longitudinal length of the carrier pipe assembly. In particular containment pipe assemblies, the first carrier pipe joint section is axially movable relative to the second carrier pipe joint section such that a relative axial movement of the first carrier pipe joint section proportionally changes the second longitudinal length. In some instances, the axial movement of the first containment pipe joint section relative to the second containment pipe joint section is independent of the axial movement of the first carrier pipe joint section relative to the second carrier pipe joint section. In certain embodiments the first containment pipe joint section may be fixed to one of the first carrier pipe joint section and the second carrier pipe joint section. The second containment pipe joint section may also be fixed to one of the first carrier pipe joint section and the second carrier pipe joint section. In various embodiments, a containment pipe assembly may optionally include a containment pipe extension. A containment pipe extension may be fixed to the movement of one of the containment pipe piston or the containment pipe piston guide. Alternately, or additionally, some embodiments of a carrier pipe assembly may comprise a carrier pipe extension. A carrier pipe extension may be fixed to the movement of one of the carrier pipe piston or the carrier pipe piston guide.

In an additional general aspect of the present invention, a first containment pipe joint section comprises a containment pipe piston and the second containment pipe joint section comprises a containment pipe piston. The containment pipe piston may be axially movable from a first position to a second position within and relative to the containment pipe piston guide such that the longitudinal length defined by the first and second containment pipe joint sections increases when the containment pipe piston moves from the first position to the second position and decreases when the containment pipe piston moves from the second position to the first position. In various embodiments, the first carrier pipe joint section comprises a carrier pipe piston and the second carrier pipe joint section comprises a carrier pipe piston guide. The carrier pipe piston is axially movable from a first position to a second position within and relative to the carrier pipe piston guide such that the longitudinal length defined by the first and the second carrier pipe joint sections increases when the carrier pipe piston moves from the first position to the second position and decreases when the carrier pipe piston moves from the second position to the first position. In certain non-limiting embodiments, an expandable joint comprises a contact surface configured to support positioning of the piston within the piston guide. In one instance, the contact surface comprises a surface complementary to an external surface of the piston. The contact surface may also be fixed relative to the axial movement of one of the piston and the piston guide.

In still another general aspect of the present invention, at least one of a first containment pipe joint section and a first carrier pipe joint section comprises a piston and at least one of a second containment pipe joint section and a second carrier pipe joint section comprises a piston guide. In some such instances, the piston is axially movable from a first position to a second position within and relative to the pipe piston guide. In particular embodiments, the piston's relative axial movement from the first position to the second position increases the longitudinal length of one of the containment pipe assembly and the carrier pipe assembly. In some such embodiments, the piston's relative axial movement from the second position to the first position decreases the longitudinal length of one of the containment pipe assembly and the carrier pipe assembly.

In even yet another general aspect of the present invention, an expandable joint comprises a seal at least partially disposed between a piston surface and a piston guide surface. In one instance, the seal is configured to substantially maintain an interior seal when the piston moves from the first position to the second position. Such a seal may be fixed relative to an axial movement of one of the piston and the piston guide. A seal may further comprise a complementary surface which itself has a complementary dimension to a surface of at least one of the piston and the piston guide. In certain embodiments, the seal comprises an o-ring.

In even still another general aspect of the present invention, a double containment pipe is provided comprising first and second containment pipe joint sections configured to radially rotate relative to each other while substantially maintaining an interior seal of the containment pipe assembly. In some such embodiments, a relative radial rotation of the first and the second containment pipe joint sections may be independent of a relative axial movement of the first and the second containment pipe joint sections. In further embodiments, the first and the second carrier pipe joint sections may be configured to radially rotate relative to each other while substantially maintaining an interior seal of the carrier pipe assembly. In some instances, a relative radial rotation of the first and the second carrier pipe joint sections is independent of a relative axial movement of the first and the second carrier pipe joint sections. In yet other embodiments, both a relative radial rotation and a relative axial movement of the first and the second carrier pipe joint sections are independent of a relative radial rotation and a relative axial movement of the first and the second containment pipe joint sections.

In additional aspects of the present invention a double containment pipe or expansion joint may include one or more accessory features such as a limiter, for example. A limiter may be configured to limit a first direction of axial movement of the piston. A limiter may comprise a first stop located at a piston surface and a first stopper having a surface fixed relative to the first direction of axial movement of the piston. A limiter may thus limit the first direction of axial movement of the piston when the first stop abuts the first stopper. A limiter may also be configured to limit a second direction of axial movement of the piston. Such a limiter may comprise a second stop comprising a piston surface and a second stopper comprising a surface that is fixed relative to the second direction of axial movement of the piston. As such, the second direction of axial movement of the piston may be limited when the second stop abuts the second stopper. Some of the numerous variants of stoppers may comprise a surface perpendicular to the first direction of axial movement. In particular embodiments, the axial movement of the piston may be limited in a first axial direction and the piston may be selectively removable from the expandable joint in a second direction.

Additional accessory features of a double containment pipe or expansion joint disclosed herein include a conduit. A conduit may comprise a channel between an exterior and interior surface of the containment pipe assembly and may include a tap. The tap may be selectively sealable from the exterior surface with a drainage plug, for example.

In one general aspect of the present invention, a method is described comprising providing a double containment pipe system that comprises an inner carrier pipe assembly and an outer containment pipe assembly and carrying a carrier fluid in the carrier pipe assembly. The double containment pipe system comprises at least one joint comprising a first joint section comprising a piston, and a second joint section comprising a piston guide. The piston is axially movable from a first position to a second position within and relative to the piston guide. The first and second joint sections define a longitudinal length that increases when the piston moves from the first position to the second position and that decreases when the piston moves from the second position to the first position. In some instances, the outer containment pipe assembly includes a containment pipe joint having a first containment pipe joint section and a second containment pipe joint section. The first containment pipe joint section may be axially movable relative to the second containment pipe joint section. The first and the second containment pipe joint sections may further define a longitudinal length such that a relative axial movement of the first containment pipe joint section proportionally changes the longitudinal length. In some instances, the inner carrier pipe assembly includes a carrier pipe joint having a first carrier pipe joint section and a second carrier pipe joint section. The first carrier pipe joint section may be axially movable relative to the second carrier pipe joint section. The first and second carrier pipe joint sections may further define a longitudinal length such that a relative axial movement of the first carrier pipe joint section proportionally changes the longitudinal length. In some instances, a relative axial movement of the first containment pipe joint section to the second containment pipe joint section is independent of a relative axial movement of the first carrier pipe joint section to the second carrier pipe joint section.

In another general aspect of the present invention, a double containment pipe includes an outer containment pipe assembly, an inner carrier pipe assembly at least partially disposed within the containment pipe assembly, and a first means for allowing the containment pipe assembly to axially expand from a first containment pipe position to a second containment pipe position and to axially contract from the second containment pipe position to the first containment pipe position. Additionally, a second means may also be provided for allowing the carrier pipe assembly to axially expand from a first carrier pipe position to a second carrier pipe position and to axially contract from the second carrier pipe position to the first carrier pipe position. In some instances, the first and second means allow the carrier pipe assembly to axially move between the first and second carrier pipe positions independent of the movement of the containment pipe between the first and second containment pipe positions. In various embodiments, accessory features such as a limiter means may also be provided. A limiter means may limit the axial movement of at least one of the containment pipe assembly and the carrier pipe assembly. Another accessory feature may include a sealing means for maintaining a substantially sealed path within the carrier pipe assembly for a carried fluid when the carrier pipe moves between the first and second carrier pipe positions

These and other objects and advantages of the present invention shall be made apparent from the accompanying drawings and the description thereof.

### FIGURES

The novel features of the various embodiments are set forth with particularity in the appended claims. The various embodiments, however, both as to organization and methods of operation, together with advantages thereof, may best be understood by reference to the following description, taken in conjunction with the accompanying drawings as follows.

FIG. 1 is a longitudinal cross-section in perspective of one embodiment of an expandable joint comprising a double containment pipe configuration with containment pipe and carrier pipe assemblies in a contracted position.

FIG. 2 is a longitudinal cross-section of the expandable joint embodiment of FIG. 1 with the containment pipe assembly in an extended position and the carrier pipe assembly in a contracted position.

FIG. 3 is a perspective view of one embodiment of an expandable joint comprising a double containment pipe configuration with the containment pipe in an extended position, according to one embodiment.

FIG. 4 is a longitudinal cross-section in perspective of one embodiment of an expandable joint comprising a double containment pipe configuration with the containment pipe and carrier pipe assemblies in a contracted position

FIG. 5 is a longitudinal cross-section in perspective of one embodiment of an expandable joint comprising a double containment pipe configuration with the containment pipe and carrier pipe assemblies in a contracted position.

### DESCRIPTION

Various embodiments of the present invention are directed to a double containment pipe system and method of using the same. Before explaining the various embodiments of the double containment pipe in detail, it should be noted that the embodiments are not limited in their application of use to the details of construction or arrangement of parts illustrated in the context of the accompanying drawings and description. The illustrative embodiments may be implemented or incorporated in other embodiments, variations, or modifications and may be practiced or carried out in various ways. For example, the expandable joint configurations explained below are illustrative only and not meant to limit the scope or application thereof. Furthermore, unless otherwise stated, the terms and expressions employed herein have been chosen for the purpose of describing the illustrative embodiments. For example, expandable joint components described as movable refer to relative movement. Thus, a piston moves axially when the piston remains stationary and a piston guide, for example, moves axially relative to the piston.

As described herein, an expandable joint system comprises one or more assembly joints comprising a first joint section and a second joint section. The first joint section is movable relative to the second joint section. Relative movement may be axial and comprise a portion of a first joint section moving within a portion of a second joint section or vice versa. For example, in some embodiments a longitudinal length defined by first and second joint sections may increase or decrease proportionally to the net relative axial movements between joint sections. In certain embodiments, a first joint section comprises a piston and a second joint section comprises a piston guide. The piston is configured to move axially within and relative to the piston guide such that lateral portions of the piston and piston guide comprise an overlap region along the longitudinal length of the first and second joint sections. In one such embodiment, the length defined by the first and second joint sections contracts or decreases as the length of the lateral overlap region increases. Conversely, the length defined by the first and second joint sections expands or increases as the length of the lateral overlap region decreases.

In some embodiments, a first piston and a first piston guide are configured to radially rotate relative to each other. Such relative rotation may be independent of relative axial movement. In certain embodiments, a second piston and a second piston guide are configured to radially rotate relative to each other. Such relative rotation may be independent of relative axial movement between the second piston and second piston guide. In various embodiments, the first piston and the first piston guide radially rotate or axially move independent of relative radial rotation or axial movement of the second piston and second piston guide. In some embodiments, the second piston and the second piston guide radially rotate or axially move independent of relative radial rotation of axial movement of the first piston and first piston guide.

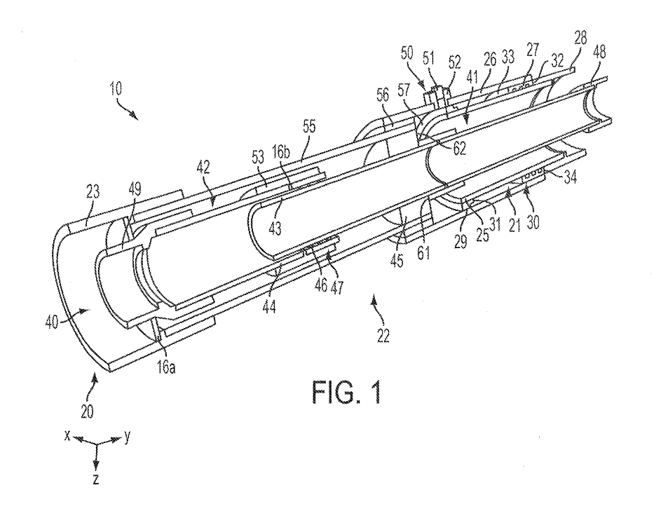

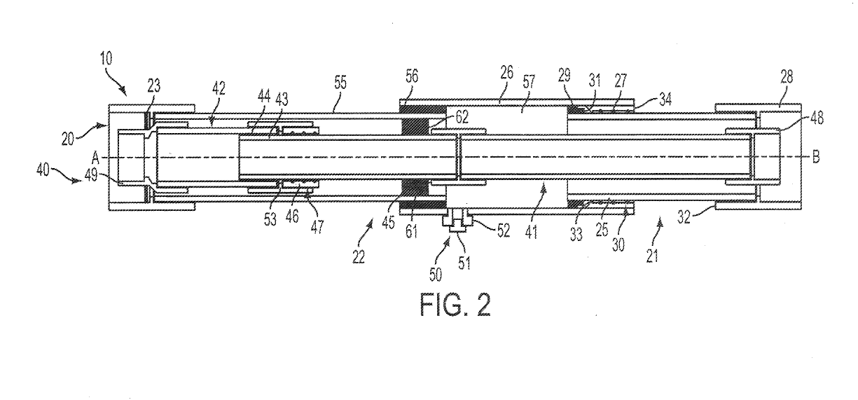

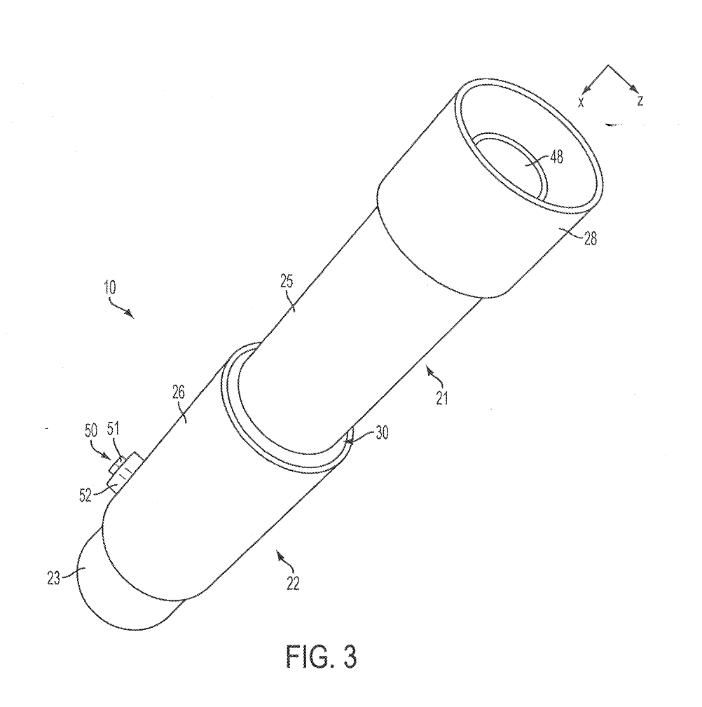

FIG. 1 is illustrative of one non-limiting embodiment of an expandable joint 10 comprising a double containment pipe configuration. The expandable joint 10 comprises an inner carrier pipe assembly 40 and an outer containment pipe assembly 20. The containment pipe assembly 20 includes a first assembly joint. The first assembly joint further comprises a first and a second joint section 21, 22. The first joint section 21 comprises a containment pipe piston 25 and the second joint section 22 comprising a containment pipe piston guide 26. The containment pipe piston 25 is axially movable along the longitudinal axis A-B, shown in FIG. 2. Axial movement of the containment pipe piston 25 is relative to the containment pipe piston guide 26. The containment pipe piston 25 is also radially rotatable in either the clockwise or counter clockwise direction. Radial rotation of the containment pipe piston 25 is relative to the containment pipe piston guide 26. In the embodiment of FIG. 1, the containment pipe piston guide 26 also comprises an optional containment pipe extension 55. In other embodiments, such as the embodiment illustrated in FIG. 3, the containment pipe assembly 20 does not comprise a containment pipe extension.

The containment pipe assembly 20 of FIG. 1 further comprises a contact surface 29. In this example embodiment, the contact surface 29 comprises an annular surface about the containment pipe piston 25 having a circumference complementary to the inner circumference of the containment pipe piston guide 26. The contact surface is supportive of the positioning of the containment pipe piston 25 within the containment pipe piston guide 26 and is movable relative to the inner surface of the piston guide 26. In other embodiments, however, the contact surface 29 may comprise a surface that is movable relative to the first joint section 21 or containment pipe piston 25.

The containment pipe assembly 20 of FIG. 1 further comprises a containment pipe seal 30 configured to substantially maintain an interior seal of the containment pipe assembly 20 when the containment pipe piston 25 moves axially within and relative to the containment pipe piston guide 26. The containment pipe seal 30 is additionally configured to substantially maintain an interior seal of the containment pipe assemble 20 when the containment pipe piston 25 radially rotates with and relative to the containment pipe piston guide 26. The particular containment pipe seal 29 depicted in FIG. 1 comprises three containment pipe o-rings 27.

First and second containment pipe couplings 28, 23 located at containment pipe assembly 20 termini are illustrated in FIG. 1. The first containment pipe coupling 28 may couple the first joint section 21 to a first anchor point. The first anchor point may be spatially fixed or moveable; however, when coupled, the first joint section 21 moves coincident with the first anchor point. The second containment pipe coupling 23 may couple the second joint section 22 to a second anchor point. The second anchor point may be spatially fixed or moveable; however, when coupled, the second joint section 22 moves coincident with the second anchor point.

The containment pipe assembly 20 of FIG. 1 further illustrates a containment pipe limiter. A limiter may limit a direction of axial movement or confine axial movement of the containment pipe piston 25 to a region within the containment pipe piston guide 26. The particular containment pipe limiter illustrated in FIG. 1 comprises an annular containment expansion stop 31 and an annular containment contraction stop 32 disposed between the containment pipe piston and the containment pipe piston guide. The containment expansion and contraction stops 31, 32 limit axial movement of the containment pipe piston 25 by bounding the piston's 25 range of axial travel when a stop 31, 32 abuts a structure that is fixed relative to the axial movement of the containment pipe piston 25. In FIG. 1, a fixed expansion stopper 33 and a fixed contraction stopper 34 are provided. In this embodiment, both fixed stoppers 33, 34 comprise a surface perpendicular to a direction of axial movement of the containment pipe piston 25 and lie along the axial path of respective fixed expansion and contraction stoppers 33, 34. As such, the total movable distance of the containment pipe piston 25 relative to the containment pipe piston guide 26 is the sum of the distance between the expansion stop 31 and the fixed expansion stopper 32 and the distance between the contraction stop 33 and the fixed contraction stopper 34. In FIG. 1, the containment pipe assembly 20 is depicted in a fully contracted position. In this position, the containment contraction stop 32 abuts the fixed contraction stopper 34. Illustratively, FIG. 2 depicts the containment pipe assembly 20 in an extended position. When the containment pipe assembly 20 is fully extended, as in the non-limiting embodiment illustrated in FIG. 3, the expansion stop 31 abuts the fixed expansion stopper 33 (not shown).

In certain embodiments, double containment joints comprising independently expandable or contractible assembly joints may be configured to relieve a structural stress due to a mechanical movement or thermal expansion or contraction of a containment pipe or carrier pipe assembly. For example, a double containment pipe system installed within a facility wherein an exterior of the containment pipe system is exposed to an ambient temperature of 60° F. and an interior of the carrier pipe assembly is exposed a temperature of 150° F. could expect a differential in expansion of the carrier pipe assembly compared to that of the containment pipe assembly. Additionally, embodiments providing independent expansion or contraction between containment pipe and carrier pipe assemblies may be particularly beneficial in applications wherein containment pipe and carrier pipe assemblies are exposed to environments comprising varied temperatures or temperature changes. For example, a carrier pipe assembly of a double containment pipe system may carry carriables at temperatures ranging from 40° F. to 300° F. When a containment pipe assembly is not simultaneously exposed to the same temperature changes as the carrier pipe assembly, the carrier pipe assembly may expand or contract at a rate different than that of the containment pipe assembly. This may occur even when assemblies are simultaneously exposed to equivalent increases or decreases in temperature, such as when surrounding environments comprise different molecular states or when components of the containment pipe assembly comprise different thermal properties than components of the carrier pipe assembly. Where the containment pipe and carrier pipe assemblies in the above examples comprise fixed lengths of pipe that share common anchor points the differences in their expansion or contraction may cause structural stresses and result in a failure of an interior seal. Individually coupling respective assemblies to containment and carrier pipe assemblies of an expandable joint may relieve this stress by allowing independent expansion or contraction of pipe assemblies without substantially compromising interior seals.

FIG. 1 further illustrates an expandable joint 10 having a containment pipe conduit 50. As depicted, the conduit 50 comprises a tap 52 and a plug 51. The tap 52 defines a channel between an exterior and interior surface of the containment pipe assembly 20. A plug 51 is also provided. The plug 51 is selectively removable to expose an interior cavity 57 of the containment pipe assembly 20. The tap 52 comprises an access point of sufficient size to allow drainage of fluid, gas, or other carriable from the containment pipe that is captured in the cavity 57. In certain embodiments, carriables that may have leaked from the carrier pipe assembly 40 may be captured within the cavity 57 and be drainable through the tap 51.

The carrier pipe assembly 40 depicted in FIG. 1 includes an assembly joint comprising a first joint section 41 and a second joint section 42. The first joint section 41 comprises a carrier pipe piston 43 and the second joint section 41 comprises a carrier pipe piston guide 44. The carrier pipe piston 43 is axially movable within the carrier pipe piston guide 44. Axial movement of the carrier pipe piston 43 is relative to the carrier pipe piston guide 44. The carrier pipe piston 43 is also radially rotatable in either the clockwise or counterclockwise direction. Radial rotation of the carrier pipe piston 43 is relative to the carrier pipe piston guide 44.

The carrier pipe assembly 40 of FIG. 1 further comprises a contact surface 45. In the example embodiment, the contact surface 45 comprises an annular surface about the inner circumference of the containment pipe assembly 20 with an inner circumference complementary to the external circumference of the carrier pipe piston 43. The contact surface 45 is fixed relative to the axial movement of the carrier pipe piston 43 and is supportive of the positioning of the carrier pipe piston 43 within the containment pipe assembly 20 and carrier pipe piston guide 44.

The carrier pipe assembly 40 of FIG. 1 also illustrates a carrier pipe seal 47 configured to substantially maintain an interior seal of the carrier pipe assembly 40 when the carrier pipe piston 43 moves axially or radially rotates within and relative to the carrier pipe piston guide 44. The particular carrier pipe seal 47 depicted in FIG. 1 comprises three carrier pipe o-rings.

First and second carrier pipe couplings 48, 49 located at carrier pipe assembly 40 termini are illustrated in FIG. 1. The first carrier pipe coupling 48 may couple the first joint section 41 to a first anchor point. The first anchor point may be spatially fixed or moveable; however, when coupled, the first joint section 41 moves coincident with the first anchor point. The second carrier pipe coupling 49 may couple the second joint section 42 to a second anchor point. The second anchor point may be spatially fixed or moveable; however, when coupled, the second joint section 42 moves coincident with the second anchor point.

The carrier pipe assembly 40 of FIG. 1 illustrates the assembly 40 in a contracted position and comprises a carrier pipe limiter. A limiter may limit a direction of axial movement or confine axial movement of the carrier pipe piston 43 to a region within the carrier pipe piston guide 44. The particular carrier pipe limiter illustrated in FIG. 1 comprises a carrier contraction stop 61. In this embodiment, the carrier contraction stop 61 comprises a raised surface about the out circumference of the carrier pipe piston 43. The carrier contraction stop 61 limits axial movement of the carrier pipe piston 43 by bounding the piston's 43 range of axial travel when the stop 61 abuts a structure fixed relative to the carrier pipe piston 43. In FIG. 1, a fixed contraction stopper 62 comprising a surface fixed relative to the axial movement of the carrier piston 43 is provided. In particular, the fixed contraction stopper 62 comprises a surface perpendicular to axial movement of the carrier pipe piston 43 in the contraction direction and lies along the axial path of the carrier contraction stop 61 such that contraction is limited when the carrier contraction stop 61 abuts the fixed contraction stopper 62.

In particular embodiments, an expandable joint 10 may also comprise one or more internal support features. The embodiment illustrated in FIG. 1, for example, depicts internal supports comprising a containment pipe extension support 56. Such an internal support may be beneficial when a containment pipe extension 55 comprises a separate section of pipe. For example, an annular containment pipe extension support may be beneficial when a large diameter containment pipe extension is coupled to a small diameter containment pipe piston guide. Containment pipe extension supports 56 having surfaces exposed to an internal or external environment are preferably sealable to provide a barrier to an internal or external transfer.

The embodiment of FIG. 1 also depicts an internal carrier pipe o-ring support 53 configured to assist in positioning the carrier pipe piston guide 44 and the carrier pipe o-rings 46 with respect to the carrier pipe piston 43.

FIG. 1 also includes carrier joint locking members 16a, 16b. A carrier joint locking member 16 unites the axial movements of a carrier pipe joint section with that of a containment pipe joint section. In some embodiments, uniting axial movement of two joint sections allows both containment and carrier pipe assemblies to be anchored relative to a single point at a first terminus while being independently expandable or contractible at a second terminus. In FIG. 1, the second carrier pipe joint section 42 is united with the second containment pipe joint section 22 by joint locking members 16a, 16b. Joint locking member 16b comprises an annular surface fixed to the second containment joint section 22 and having a circumference less than an adjacent circumference of the second carrier pipe joint 42. Joint locking member 16a comprises an annular surface fixable to the second containment pipe joint section 22 and having a circumference less than an adjacent circumference of the second carrier pipe 42. In this non-limiting embodiment, joint locking member 16a may be configured such that it may be selectively removed to allow the second carrier joint section 42 to be axially pulled or pushed from the interior of the containment pipe assembly 20. Joint locking member 16a may be fixed to the containment pipe assembly 20, thereby locking the second carrier pipe joint section 42 within the containment pipe assembly 40 by, for example, fixing locking member 16a to a containment pipe structure by a known method such as welds, adhesives, clamps, pins, or bolts. In some embodiments, joint locking member 16a may be fixed to the containment pipe assembly 20 by counter pressure when the containment pipe or carrier pipe assembly 20, 40 is coupled to an anchor point. In some such instances, a coupling with an anchor point physically holds, and thus fixes, joint locking member 16a to a position within the containment pipe assembly 20 such that the axial movement of the second carrier pipe joint section 42 is united with the axial movement of the second containment pipe joint section.

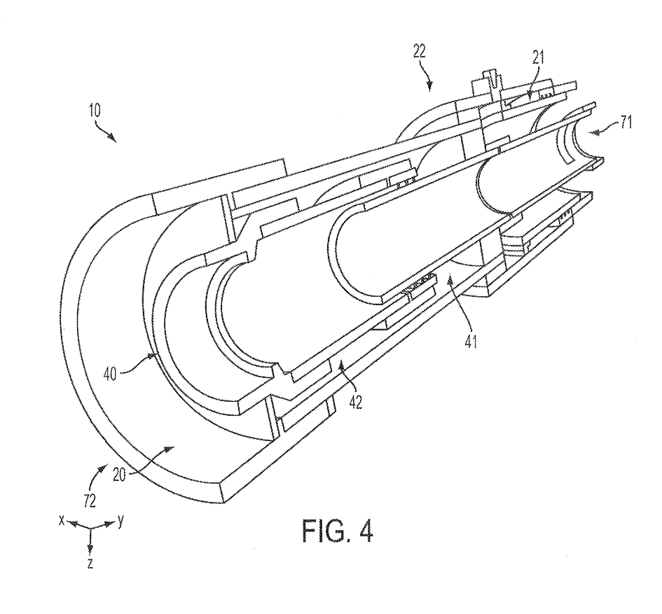

FIG. 4 illustrates one non-limiting embodiment of an expandable joint 10. The containment pipe assembly 20 comprises an alignment of two joint sections. The first joint section 21 is configured to telescopically nest within or be partially enveloped by a portion of a second joint section 22. The carrier pipe assembly 40 comprises an alignment of two joint sections of a substantially sealed length of piping. The first joint section 41 is configured to telescopically nest within or be partially enveloped by a portion of a second joint section 42. The expandable joint 10 further comprises a first terminus 71 and a second terminus 72. The first terminus 71 is movable relative to the second terminus 72 such that the distance between the first terminus 71 and the second terminus 72 will increase or decrease in proportion to the net relative movement between the termini 71, 72. In some instances, the first terminus 71 may be coupled to a first anchor point and the second terminus 72 may be coupled to a second anchor point.

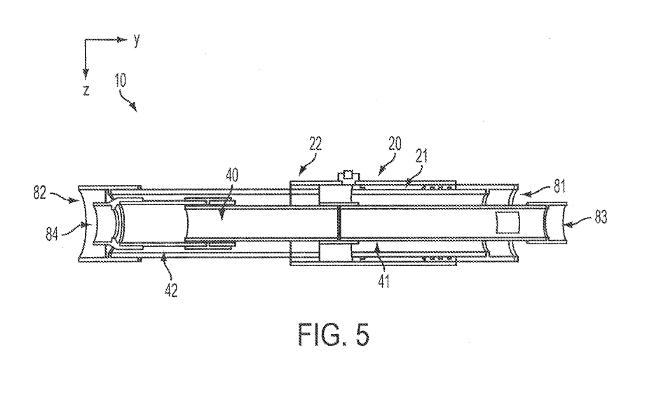

FIG. 5 illustrates one non-limiting embodiment of an expandable joint 10. The containment pipe assembly 20 comprises an alignment of two joint sections. The first joint section 21 is configured to move axially relative to the second joint section 22. The containment pipe assembly further comprises a first terminus 81 and a second terminus 82. The first terminus 81 is axially movable relative to the second terminus 82 such that the distance between the first terminus 81 and the second terminus 82 will increase or decrease in proportion to their relative movements. The carrier pipe assembly 40 comprises an alignment of two joint sections of a substantially sealed length of piping. The first joint section 41 is configured to axially move relative to the second joint section 42. The carrier pipe assembly further comprises a third terminus 83 and a fourth terminus 84. The third terminus 83 is movable relative to the fourth terminus 84 such that the distance between the third terminus 83 and the fourth terminus 84 will increase or decrease in proportion to their relative movements. Relative axial movement between the first terminus 81 and the second terminus 82 is independent of the relative axial movement between the third terminus 83 and the fourth 84 terminus. The first terminus 81 may be coupled to a first anchor point and the second terminus 82 may be coupled to a second anchor point. The third terminus 83 may be coupled to a third anchor point and the fourth terminus 84 may be coupled to a fourth anchor point. When coupled, a relative axial movement of the first anchor point is not fixed to a relative axial movement of the third anchor point; however, axial movements of the second and third anchor points are united such that they do not move axially relative to each other.

Expandable joint piping or construction may comprise flexible or rigid portions and may comprise any material or combination of materials consistent with this disclosure. For example, piping or construction may comprise a flexible material such as nylon, silicone, or rubber. In various preferred embodiments, piping and construction components comprise a polymeric material such as ABS, CPVC, PE, PEX, PP, PVC, PVDF, or PEX, for example. In some embodiments, piping or construction comprise a metal or alloy thereof such as steel, iron, platinum, aluminum, or copper, for example. Piping or construction may furthermore be straight or comprise pipe sections defining curved or irregular longitudinal lengths, circumferences, or diameters. For instance, in some embodiments one or more joint sections may comprise termini arranged at non-linear angles, such as perpendicular. In addition, the above described termini may be configured for telescopic movement relative to adjacent joint sections.

In certain embodiments, an expandable joint comprises a portion of a double containment pipe having an inner carrier pipe assembly that is at least partially contained by an outer containment pipe assembly. The containment pipe assembly may comprise a continuous path of one or more cavities for containment of carriables, such as liquids or fluids. In various embodiments, the containment pipe assembly comprises an alignment of independently sealed cavities for the containment of carriables. In some embodiments, however, the containment pipe assembly comprises a continuous path or an alignment of cavities having one or more selectively permeable seals between or among cavities or assembly joint surfaces. The carrier pipe assembly may similarly comprise a continuous path or one or more cavities for the carrying of carriables. Such paths or cavities may also comprise selectively permeable seals between or among cavities or assembly joint surfaces.

In various embodiments, containment and carrier pipe assemblies each comprise an assembly joint, e.g., a containment pipe assembly joint and a carrier pipe assembly joint each configured to provide independent expansion or contraction of at least a portion of their respective assemblies. According to certain embodiments, an assembly joint comprises a first joint section comprising a piston. The piston may be configured to move within and relative to a portion of a second joint section comprising a piston guide. In some such embodiments, relative axial movement between a containment pipe piston and a containment pipe piston guide is independent of relative axial movement between a carrier pipe piston and a carrier pipe piston guide; however, movements of the containment and carrier pipe piston guides are united and coincident. In one embodiment, for example, the location and movement of a second carrier pipe joint section is axially fixed to a second containment pipe joint section. In a preferred embodiment, a longitudinal length defined by first and second joint sections of the containment and carrier pipe assemblies increases or decreases proportionally to the net relative axial movement between respective piston and piston guide; however, relative axial movement between the containment pipe piston and the containment pipe piston guide is independent of the relative axial movement between the carrier pipe piston and the carrier pipe piston guide. Hence, the longitudinal length defined by the first and second containment pipe joint sections is unaffected by the net relative axial movement between the carrier pipe piston and carrier pipe piston guide and vice versa.

In some embodiments, a containment pipe piston may be moveable such that it is radially rotatable relative to a containment pipe piston guide. Relative radial rotation of the containment pipe piston may be within or around a circumference defined by the containment pipe piston guide. In certain embodiments, the containment pipe piston may radially rotate relative to the containment pipe piston guide in either a clockwise or counterclockwise direction while substantially maintaining an interior seal within the containment pipe assembly. Thus, in certain embodiments, the containment pipe piston guide may radially rotate clockwise relative to the containment pipe piston while substantially maintaining an interior seal within the containment pipe assembly. In one embodiment, radial rotation of the containment pipe piston is not limited in the clockwise or counterclockwise direction. In other embodiments, relative radial rotation of the containment pipe piston is completely or partially limited in the clockwise, the counterclockwise, or in both directions. In some such embodiments, radial rotation of the containment pipe piston may be limited beyond a specified number of turns or degrees of rotation relative to the containment pipe piston guide, for example. In various embodiments, relative radial rotation of the containment pipe piston may be independent of radial or axial positioning or radial or axial movement of the containment pipe piston guide.

In certain embodiments, a carrier pipe piston may be moveable such that it is radially rotatable relative to a carrier pipe piston guide. Such relative radial rotation of the carrier pipe piston may be within or around a circumference defined by the carrier pipe piston guide. In certain embodiments, the carrier pipe piston may radially rotate relative to the carrier pipe piston guide in either a clockwise or counterclockwise direction while substantially maintaining an interior seal within the carrier pipe assembly. Thus, in certain embodiments, the carrier pipe piston guide may radially rotate clockwise relative to the carrier pipe piston while substantially maintaining an interior seal within the carrier pipe assembly. In various embodiments, relative radial rotation of the carrier pipe piston may be independent of a radial position or movement of the carrier pipe piston guide. In one embodiment, radial rotation of the carrier pipe piston is not limited in the clockwise or counterclockwise direction. In other embodiments, relative radial rotation of the carrier pipe piston is completely or partially limited in the clockwise, the counterclockwise, or in both directions. In some such embodiments, radial rotation of the carrier pipe piston may be limited beyond a specified number of turns or degrees of rotation relative to the carrier pipe piston guide, for example. In various embodiments, relative radial rotation of the carrier pipe piston may be independent of radial or axial positioning or radial or axial movement of the carrier pipe piston guide.

In some embodiments, a containment pipe piston or piston guide radially rotates relative to a carrier pipe piston or piston guide. In certain such embodiments, the relative radial rotation of the containment pipe piston or piston guide may be independent of radial positioning or movement of the carrier pipe piston or piston guide. In various embodiments, relative radial rotation of the containment pipe piston or piston guide may be independent of axial positioning or movement of the carrier pipe piston or piston guide. Thus, in certain embodiments, radial rotation of the carrier pipe piston or piston guide relative to the containment pipe piston or piston guide is independent of both the axial and radial positioning and movement of the containment pipe piston or piston guide.

In various embodiments, a piston may be selectively fixed to a piston guide such that relative axial movement between the piston and piston guide is prevented. It is of course contemplated that one or more unanchored joint sections may be aligned or arranged between anchored or anchoring joint sections or anchor points such that portions of unanchored sections axially move within or in respect to other unanchored sections. For example, an alignment of multiple unanchored telescoping joint sections may lie between two anchored joint sections and any combination of anchored or unanchored sections may comprise a joint section. Such workarounds by addition of parts remain within the spirit of this disclosure.

In certain embodiments, portions of adjacent joint sections may comprise complementary dimensions. For instance, an inner circumference, diameter, or surface feature of a first joint section may be slightly greater than an outer circumference, diameter, or surface feature of a second joint section such that the first joint section may axially move relative to the second joint section while moving along the complementary dimension of the second joint section. Such complementary dimensions may comprise internal support or positioning components that are supportive of the axial positioning or movement of a joint section. In some embodiments, complementary dimensions provide seals for assembly joints. In various embodiments, a complementary dimension comprises a groove or rail between an external surface of a first joint section and an interior surface of a second joint section such that the first joint section may axially move within the second joint section while translating along a complementary groove or rail of the interior surface of the second joint section.

Various embodiments of expandable joints may also comprise one or more couplings configured to couple adjacent pipes, joint sections, or anchor points. Coupling may be via fittings, collars, sockets, locks, threads, bolts, compression, brackets, pins, latches, flanges, anchors, or known coupling method. In a preferred embodiment, a coupling comprises a connection between coupled components that is substantially sealed from the external environment. In a further embodiment, a coupling comprises a connection that substantially contains a carriable within one or both coupled components. To aid in providing a seal between coupled components, some embodiments may employ one or more sealants such as cement, a compressed material, containing tape, a complementary elastomeric material, a synthetic polymer, a gasket, an adhesive, or sealing method known in the art.

One non-limiting coupling described herein comprises a rigid coupling that substantially unites the axial movements of coupled components, such as a joint section coupled to an anchor point, for example. Another non-limiting coupling described herein comprises an adjustable coupling. An adjustable coupling may comprise a telescopic assembly joint between two joint sections wherein at least a portion of a first joint section is movable within and relative to at least a portion of a second joint section. For example, a telescopic assembly joint may be adjustable such that the distance defined by the longitudinal length of coupled joint sections may expand or contract while substantially maintaining a seal between the joint's interior and exterior environments. In some embodiments, a coupling comprising a telescopic joint may further allow independent radial rotation between joint sections. In certain variations, a telescopic joint may allow independent radial rotation and axial movement between joint sections while substantially maintaining an interior seal of the joint. In one embodiment, a coupling may provide an amount of lateral movement or play between coupled components while still substantially maintaining an interior seal of the joint.

In various embodiments, an assembly joint comprises two or more aligned pipe sections of a substantially sealed length of piping. In one embodiment, a portion of a first joint section is configured to telescopically nest within or be partially enveloped by a portion of a second joint section. In particular embodiments, the first joint section comprises a first piston located at a first terminus and a second piston located at a second terminus. The first piston is configured to axially move within and relative to a portion of the second joint section comprising a first piston guide. The second piston is configured to axially move within and relative to a portion of a third joint section comprising a second piston guide. Alternately, a first joint section may comprise two piston guides, each configured to accept or partially envelop pistons of adjacent joint sections. In yet other embodiments, the first joint section comprises multiple pistons or piston guides configured to couple with and axially move relative to adjacent joint sections.

In some embodiments, an assembly joint comprises an alignment of three joint sections. In one embodiment the first and second joint sections are axially movable relative to each other. The third joint section lies between the first and second joint sections and comprises a first portion fixed to the movement of the first joint section and a second portion fixed to the movements of the second joint section. The third joint section may comprise flexible or compressible material or a structure capable of maintaining an interior seal within the joint when joint sections undergo axial movement.

In various embodiments, a piping system according to this disclosure comprises one or more expandable joints sequentially aligned or aligned within the piping system. The expandable joint may be coupled at a first terminus to an anchor point comprising a first double containment pipe. The first double containment pipe may be configured to feed a carriable to a first carrier pipe terminus of the expandable joint while substantially maintaining an interior seal of the carrier pipe assembly. The expandable joint may further be coupled at a second terminus to a second anchor point comprising a second double containment pipe. The second double containment pipe may be configured to receive a carriable from the second terminus of the carrier pipe assemble while substantially maintaining an interior seal of the carrier pipe assembly. In some embodiments, a piping system comprises an alignment of piping that is not surrounded by containment pipe. Such an alignment of single piping may be configured to couple to a carrier pipe assembly of a double containment pipe while substantially maintaining an interior seal of the carrier pipe assembly. In certain embodiments, the double containment pipe comprises an expandable joint.

In various embodiments a method is provided comprising providing a double containment pipe system and carrying a carriable in an inner carrier pipe. In addition to the inner carrier pipe, the double containment pipe system includes an outer containment pipe and at least one joint. The joint comprises a first joint section having a piston and a second joint section having a piston guide. The first and second joint sections define a longitudinal length. The piston is axially movable from a first position to a second position within and relative to the piston guide. When the piston moves from the first position to the second position, the longitudinal length increases. Additionally, when the piston moves from the second position to the first position, the longitudinal length decreases. In a further embodiment of the method, the outer containment pipe comprises a containment pipe joint. The containment pipe joint includes first and second containment pipe joint sections. The first and second containment pipe joint sections define a containment pipe assembly longitudinal length. The first containment pipe joint section is axially movable relative to the second containment pipe joint section such that a relative axial movement of the first containment pipe joint section proportionally changes the containment pipe assembly longitudinal length. In yet a further embodiment of the method, the inner carrier pipe comprises a carrier pipe joint. The carrier pipe joint includes first and second carrier pipe joint sections. The first and second carrier pipe joint sections define a carrier pipe assembly longitudinal length. The first carrier pipe joint section is axially movable relative to the second carrier pipe joint section such that a relative axial movement of the first carrier pipe joint section proportionally changes the carrier pipe assembly longitudinal length. In yet even a further embodiment of the method, a relative axial movement of the first containment pipe joint section to the second containment pipe joint section is independent of the relative axial movement of the first carrier pipe joint section to the second carrier pipe joint section.

Axial movement within an assembly joint may be driven by an internal or external condition, such as thermal expansion or contraction, for example. In various embodiments, an external force such as a relative movement of an anchor point in respect to a another anchor point may drive a movement. In some embodiments, movement may be driven by a pressure differential, such as following introduction or release of a fluid or gas from an interior of a joint assembly. In certain embodiments, mechanical components such as gears, threads, or locking members may aid in expanding, contracting, or maintaining an achieved longitudinal length. In some embodiments, one or more assembly joints may be compressed to a contracted position such that the longitudinal length defined by the one or more contracted assembly joint sections is reduced. In various embodiments, compressing an assembly joint to a contracted position may aid in removal or installation of a piping, an expandable joint, or portions thereof.

Radial rotation within an assembly joint may be driven by an internal or external condition, such as a mechanical drive, for example. In various embodiments, an external force such as a relative rotational movement of an anchor point in respect to another anchor point my drive a radial rotation. In certain embodiments, mechanical components such as gears, threads, bearings, or locking members may aid or prevent radial rotation. In some embodiments, radially rotating an assembly joint may aid in the removal or installation of piping, an expandable joint, or portions thereof.

As previously described, relative axial movement between two joint sections may proportionally increase or decrease a longitudinal length defined by the two joint sections. In some embodiments, the allowable range of a joint section's axial travel may be limited. For example, certain embodiments may comprise a limiter configured to limit a joint section's axial movement in one or both directions. In various embodiments, a limiter comprises an expansion or a contraction stop that limits a piston's axial movement or sets a boundary of axial travel of the piston when a stop abuts a structure that is fixed relative to axial movement of the piston. In one embodiment, a fixed expansion stopper and a fixed contraction stopper may aid in limiting a joint section's axial travel. In one such embodiment, both fixed stoppers comprise a surface perpendicular to the axial movement of the piston and thereby limit axial movement when a stop abuts one of the fixed stoppers. As such, the total movable distance of the piston is the sum of the distance between the expansion stop and the fixed expansion stopper and the distance between the contraction stop and the fixed contraction stopper. In embodiments comprising a limiter as to only contraction or expansion, a piston may comprise an insertable or selectively removable section of pipe.

In some embodiments, expandable joints comprise a contact surface between joint components, such as between a piston and a piston guide, for example. A contact surface preferably comprises a complementary dimension with an expandable joint component. In certain embodiments, a contact surface comprises a surface complementary to a circumference or diameter of a joint section. Such a contact surface may be supportive of a piston's positioning within a piston guide and may be movable relative to the piston or the piston guide. In various embodiments, a contact surface comprises a seal configured to substantially maintain an interior seal of an assembly joint when a piston moves axially within the containment pipe piston guide. For example, an annular contact surface about the exterior surface of a piston may contact and be axially movable relative to an inner annular surface of a piston guide. In embodiments where a piston and a contact surface axially move within a piston guide, the contact surface may be configured to substantially maintain an interior seal of the piston guide. In a preferred embodiment, a seal comprises one or more o-rings. For example, in one preferred embodiment a seal comprises an alignment of three EPDM o-rings. In some embodiments, a contact surface may substantially maintain a seal between interior compartments of the containment pipe assembly when the carrier pipe piston or piston guide radially rotate relative to the containment pipe piston or piston guide.

In some embodiments, an expandable joint may comprise a conduit. A conduit may be of sufficient size to allow drainage of fluid, gas, or carriable from the expandable joint. In one preferred embodiment, a conduit provides an accessible point in which a containment pipe piston guide may be drained of collected carriables that have leaked or escaped the carrier pipe assembly. Certain embodiments of conduits may comprise various types of valving to control pressure or temperature differentials. For example, a valve may be provided through one or more surfaces. In some instances, a valve may selectively control inflow and outflow of gas or liquid. Such selective control may assist in axial translation or function as a relief valve to decrease a pressure differential between interior and exterior environments. In some embodiments, a valve system is provided that comprises a selectively permeable membrane or filter such that only a gas or select liquids may permeate the membrane or filter and be available for release. In various embodiments, a conduit comprises one or more interstices access points. In some embodiments, access points comprise channels, holes, or taps which may be selectively opened or closed via a plug, bolt, or valve. Particular access points may aid in inspection or analysis of expansion pipe function and may comprise points of visual inspection, sensor location, or instrument placement. Access points may similarly be used to modify or repair an expandable joint function by, for example, providing a tool insertion point to access adjustable features that may limit or enhance the extent or ease of axial movement of expandable joint components or for the placement of evacuation pumps. Particular access points may also aid in determining analytical properties of carriables within the expandable joint. For example, one or more containment or carrier pipe assembly conduits may comprise insertable instruments or sensors. Insertable instruments or sensors may be used to analyze various properties such as flow, temperature, pressure, pH, radiation, noise, or chemical composition of carriables, for example.

In various embodiments, expandable joints comprise one or more joint locking members. A joint locking member unites the axial movement of a carrier pipe joint section with that of a containment pipe joint section. In some embodiments, uniting axial movement of two joint sections allows both containment and carrier pipe assemblies to be anchored relative to a single point at a first terminus while being independently expandable or contractible at a second terminus. In some embodiments, a joint locking member may comprise a surface fixed to a containment pipe joint section. The surface may comprise a region with a circumference, diameter, or dimension capable of restricting an axial movement of a carrier pipe joint section. Alternatively or additionally, a bolt, pin, or screw may be used as a locking member to unite the axial movement of a carrier pipe joint section with that of a containment pipe joint section. In certain embodiments, a joint locking member may comprise an adhesive applied between an exterior diameter of a carrier pipe joint section and an interior diameter of a containment pipe joint section. In a preferred embodiment, a joint locking member comprises an annular surface fixed to a containment joint section. The circumference of the joint locking member is less than an adjacent circumference of a carrier pipe joint section. In one embodiment, a joint locking member is fixable to a containment pipe joint section such that it may be selectively removed. Selective removal of the joint locking member may provide access to the carrier joint section or allow removal of the carrier joint section from the containment pipe assembly. A fixable joint locking member may be fixed to the containment pipe assembly by any known method, such as by welds, adhesives, clamps, pins, or bolts, for example. In some embodiments, a joint locking member may be fixed to the containment pipe assembly when the containment pipe or carrier pipe assembly is coupled to an anchor point. In some such embodiments, a coupling with an anchor point physically holds, and thus fixes, a joint locking member to a position within the containment pipe assembly by applying a counter pressure between the anchor point and the expandable joint.

This disclosure is not limited by recited example embodiments, which are intended to aid in the reader's understanding of this disclosure by combining multiple non-limiting aspects—each of which may be susceptible to rearrangement, multiplication, substitution, or addition of known equivalents by those of skill in the art. For example, joint sections referred to as pistons may be modified to function as piston guides. Similarly, in embodiments comprising an o-ring, an o-ring may be fixed to a piston or a piston guide. Those having skill in the art will recognize that placement and necessity of internal supports may be dictated by desired expandable joint arrangement. All such arrangements are contemplated herein as recognized variants of this disclosure's teachings.

What is claimed:

1. An expandable joint comprising:
a containment pipe assembly comprising a containment pipe joint, the containment pipe joint comprising:
a first containment pipe joint section,
a second containment pipe joint section, and wherein the first and second containment pipe joint sections define a containment pipe assembly longitudinal length, wherein the first containment pipe joint section is axially movable relative to the second containment pipe joint section, and wherein a relative axial movement of the first containment pipe joint section proportionally changes the containment pipe assembly longitudinal length; and
a carrier pipe assembly at least partially disposed within the containment pipe assembly and comprising a carrier pipe joint, the carrier pipe joint comprising:
a first carrier pipe joint section,
a second carrier pipe joint section, and wherein the first and second carrier pipe joint sections define a carrier pipe assembly longitudinal length, wherein the first carrier pipe joint section is axially movable relative to the second carrier pipe joint section, wherein a relative axial movement of the first carrier pipe joint section proportionally changes the carrier pipe assembly longitudinal length, and wherein the relative axial movement of the first containment pipe joint section to the second containment pipe joint section is independent of the relative axial movement of the first carrier pipe joint section to the second carrier pipe joint section.

2. The expandable joint of claim 1, wherein:
the first containment pipe joint section comprises a containment pipe piston and the second containment pipe joint section comprises a containment pipe piston guide, wherein:
the containment pipe piston is axially movable from a first position to a second position within and relative to the containment pipe piston guide, and
the containment pipe assembly longitudinal length increases when the containment pipe piston moves from the first position to the second position and the containment pipe assembly longitudinal length decreases when the containment pipe piston moves from the second position to the first position; and
the first carrier pipe joint section comprises a carrier pipe piston and the second carrier pipe joint section comprises a carrier pipe piston guide, wherein:
the carrier pipe piston is axially movable from a first position to a second position within and relative to the carrier pipe piston guide, and
the carrier pipe assembly longitudinal length increases when the carrier pipe piston moves from the first position to the second position and the carrier pipe longitudinal length decreases when the carrier pipe piston moves from the second position to the first position.

3. The expandable joint of claim 1, wherein at least one of the first containment pipe joint section and the first carrier pipe joint section comprises a piston and wherein at least one of the second containment pipe joint section and the second carrier pipe joint section comprises a piston guide, and wherein the piston is axially movable from a first position to a second position within and relative to the pipe piston guide.

4. The expandable joint of claim 3, wherein one of the containment pipe assembly longitudinal length and the carrier pipe assembly longitudinal length increases when the piston axially moves from the first position to the second position and one of the containment pipe assembly longitudinal length and the carrier pipe assembly longitudinal length decreases when the piston axially moves from the second position to the first position.

5. The expandable joint of claim 4, further comprising a seal at least partially disposed between a piston surface and a piston guide surface, and wherein the seal is configured to substantially maintain an interior seal when the piston moves from the first position to the second position.

6. The expandable joint of claim 5, wherein the seal is fixed relative to the axial movement of one of the piston and the piston guide.

7. The expandable joint of claim 6, wherein the seal comprises a complementary surface having a complementary dimension to a surface of at least one of the piston and the piston guide.

8. The expandable joint of claim 7, wherein the seal comprises an o-ring.

9. The expandable joint of claim 1, wherein the first containment pipe joint section is fixed to one of the first carrier pipe joint section and the second carrier pipe joint section.

10. The expandable joint of claim 1, wherein the second containment pipe joint section is fixed to one of the first carrier pipe joint section and the second carrier pipe joint section.

11. The expandable joint of claim 4, further comprising a limiter configured to limit a first direction of axial movement of the piston, wherein the limiter comprises a first stop located at a piston surface and a first stopper having a surface fixed relative to the first direction of axial movement of the piston, and wherein the first direction of axial movement of the piston is limited when the first stop abuts the first stopper.

12. The expandable joint of claim 11, wherein the limiter is configured to limit a second direction of axial movement of the piston, wherein the limiter further comprises a second stop comprising a piston surface and a second stopper comprising a surface fixed relative to the second direction of axial movement of the piston, and wherein the second direction of axial movement of the piston is limited when the second stop abuts the second stopper.

13. The expandable joint of claim 11, wherein the stopper comprises a surface perpendicular to the first direction of axial movement.

14. The expandable joint of claim 10, wherein the axial movement of the piston is limited in a first axial direction, and wherein the piston is selectively removable from the expandable joint in a second direction.

15. The expandable joint of claim 1, further comprising a conduit, wherein the conduit comprises a channel between an exterior and interior surface of the containment pipe assembly.

16. The expandable joint of claim 15, wherein the channel comprises a tap that is selectively sealable from the exterior surface with a drainage plug.

17. The expandable joint of claim 4, further comprising a contact surface configured to support positioning of the piston within the piston guide, wherein the contact surface comprises a surface complementary to an external surface of the piston, and wherein the contact surface is fixed relative to the axial movement of one of the piston and the piston guide.

18. The expandable joint of claim 2, wherein the containment pipe assembly comprises a containment pipe extension, and wherein the containment pipe extension is fixed to the movement of one of the containment pipe piston or the containment pipe piston guide.

19. The expandable joint of claim 2, wherein the carrier pipe assembly comprises a carrier pipe extension and wherein the carrier pipe extension is fixed to the movement of one of the carrier pipe piston or the carrier pipe piston guide.

20. The expandable joint of claim 1, wherein the first and the second containment pipe joint sections are configured to radially rotate relative to each other while substantially maintaining an interior seal of the containment pipe assembly, and wherein a relative radial rotation of the first and the second containment pipe joint sections is independent of a relative axial movement of the first and the second containment pipe joint sections.

21. The expandable joint of claim 1, wherein the first and the second carrier pipe joint sections are configured to radially rotate relative to each other while substantially maintaining an interior seal of the carrier pipe assembly, and wherein a relative radial rotation of the first and the second carrier pipe joint sections is independent of a relative axial movement of the first and the second carrier pipe joint sections.

22. The expandable joint of claim 21, wherein the first and the second carrier pipe joint sections are configured to radially rotate relative to each other while substantially maintaining an interior seal of the carrier pipe assembly, wherein a relative radial rotation of the first and the second carrier pipe joint sections is independent of a relative axial movement of the first and the second carrier pipe joint sections, and wherein both a relative radial rotation and a relative axial movement of the first and the second carrier pipe joint sections are independent of a relative radial rotation and a relative axial movement of the first and the second containment pipe joint sections.

23. A method comprising:
providing a double containment pipe system that comprises an inner carrier pipe assembly and an outer containment pipe assembly, and
carrying a carrier fluid in the carrier pipe assembly, wherein the double containment pipe system comprises at least one joint that comprises:
a first joint section comprising a piston, and
a second joint section comprising a piston guide, wherein the piston is axially movable from a first position to a second position within and relative to the piston guide, wherein, the first and second joint sections define a longitudinal length, and wherein the longitudinal length increases when the piston moves from the first position to the second position and the longitudinal length decreases when the piston moves from the second position to the first position.

24. The method of claim 23, wherein:
the outer containment pipe assembly comprises a containment pipe joint, the containment pipe joint comprising:
a first containment pipe joint section, and
a second containment pipe joint section, wherein the first and second containment pipe joint sections define a containment pipe assembly longitudinal length, wherein the first containment pipe joint section is axially movable relative to the second containment pipe joint section, and wherein a relative axial movement of the first containment pipe joint section proportionally changes the containment pipe assembly longitudinal length; and wherein:
the inner carrier pipe assembly comprises a carrier pipe joint, the carrier pipe joint comprising:
a first carrier pipe joint section, and
a second carrier pipe joint section, wherein the first and second carrier pipe joint sections define a carrier pipe assembly longitudinal length, wherein the first carrier pipe joint section is axially movable relative to the second carrier pipe joint section, wherein a relative axial movement of the first carrier pipe joint section proportionally changes the carrier pipe assembly longitudinal length, and wherein the relative axial movement of the first containment pipe joint section to the second containment pipe joint section is independent of the relative axial movement of the first carrier pipe joint section to the second carrier pipe joint section.

25. A double containment pipe comprising:
an outer containment pipe assembly;
an inner carrier pipe assembly at least partially disposed within the containment pipe assembly,
first means for allowing the containment pipe assembly to axially expand from a first containment pipe position to a second containment pipe position and to axially contract from the second containment pipe position to the first containment pipe position,
second means for allowing the carrier pipe assembly to axially expand from a first carrier pipe position to a second carrier pipe position and to axially contract from the second carrier pipe position to the first carrier pipe position, wherein the first and second means allow the carrier pipe assembly to axially move between the first and second carrier pipe positions independent of the movement of the containment pipe between the first and second containment pipe positions.

26. The double containment pipe of claim 25, further comprising:
a limiter means for limiting the axial movement of at least one of the containment pipe assembly and the carrier pipe assembly, and
a sealing means for maintaining a substantially sealed path within the carrier pipe assembly for a carried fluid when the carrier pipe moves between the first and second carrier pipe positions.
